(19) United States
(12) Patent Application Publication
(10) Pub. No.: US 2026/0036223 A1
(43) Pub. Date: Feb. 5, 2026

(54) Pin and Bracket Assembly with Verifiable Stud Attachment

(71) Applicant: Newfrey LLC, New Britain, CT (US)

(72) Inventors: Christopher GARR, Troy, MI (US); Jason A. MEYERS, Shelby Township, MI (US); Dezarai SHEPHERD, Jackson, MI (US); Tien T. DIEP, West Bloomfield Township, MI (US); Naga BATTINI, Troy, MI (US); Bradley SMALL, West Bloomfield, MI (US); Roger E. PILON, New Baltimore, MI (US)

(73) Assignee: Newfrey LLC, New Britain, CT (US)

(21) Appl. No.: 19/282,053

(22) Filed: Jul. 28, 2025

Related U.S. Application Data
(60) Provisional application No. 63/677,375, filed on Jul. 30, 2024.

(51) Int. Cl. F16L 3/02

(52) U.S. Cl. CPC F16L 3/02

(57) ABSTRACT

An assembly for securing at least one tube to a threaded stud includes a pin and a bracket. The pin includes an elongated body, a driving head disposed at one end of the pin, and a coupling head disposed at the other end of the pin. The pin has a bore for receiving the threaded stud. The bracket includes at least one finger and at least one receptacle for receiving and retaining the at least one tube. The pin is insertable into a bore in the bracket to a first position in which the at least one finger of the bracket engages the coupling head and thereby inhibits withdrawal of the pin from the bore in the bracket. The pin is rotatable relative to the bracket using the driving head to thread the pin onto the threaded stud and thereby insert the pin further into the bore in the bracket.

### CROSS-REFERENCE TO RELATED APPLICATIONS

This application claims the benefit of U.S. Provisional Application No. 63/677,375, filed on Jul. 30, 2025. The entire disclosure of the above application is incorporated herein by reference.

### FIELD

The present disclosure relates to a pin and bracket assembly with a verifiable stud attachment.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Pin and bracket assemblies are used to secure objects to a stud. Such assemblies include a pin coupled to a bracket. The pin is configured to be attached to a stud, and the bracket is configured to secure an object therein. The pin is coupled to the bracket such that securing the object within the bracket and attaching the pin to the stud secures the object to the stud. In one example, the stud is mounted to a body panel, and the object includes tubes such as brake lines. In this example, securing the tubes within the bracket and attaching the pin to the stud secures the tubes to the body panel.

If the pin is not properly attached to the stud, the pin may become detached from the stud during use. Thus, a need exists for a pin and bracket assembly providing the ability to verify that the pin is properly attached to the stud.

### SUMMARY

An example of an assembly for securing at least one tube to a threaded stud according to the present disclosure includes a pin and a bracket. The pin includes an elongated body, a driving head disposed at one end of the pin, and a coupling head disposed at the other end of the pin. The pin has a bore for receiving the threaded stud. The bracket includes at least one finger and at least one receptacle for receiving and retaining the at least one tube. The pin is insertable into a bore in the bracket to a first position in which the at least one finger of the bracket engages the coupling head and thereby inhibits withdrawal of the pin from the bore in the bracket. The pin is rotatable relative to the bracket using the driving head to thread the pin onto the threaded stud and thereby insert the pin further into the bore in the bracket.

In one aspect, the bore in the pin is unthreaded when the pin is formed, and rotating the pin relative to the bracket while the threaded stud is positioned in the bore of the pin creates internal threads in the bore of the pin.

In one aspect, the pin and the bracket are formed as a single piece with a plurality of frangible gates connecting the pin to the bracket, and inserting the pin into the bore in the bracket to the first position breaks the gates.

In one aspect, gates extend between the bore of the bracket and the coupling head of the pin.

In one aspect, the pin includes a pair of fingers configured to engage threads on the threaded stud when the threaded stud is inserted into the bore in the pin, and each finger of the pin is disposed within an opening in the pin that extends through a sidewall of the pin to the bore in the pin.

In one aspect, when the bore in the bracket is placed over the threaded stud and the bracket is seated against an object to which the threaded stud is mounted, the fingers of the pin engage the threads on the threaded stud and thereby retain the assembly on the threaded stud.

In one aspect, the pin includes a plurality of fins configured to engage threads on the threaded stud when the threaded stud is inserted into the bore in the pin. The plurality of fins include a first set of fins and a second set of fins diametrically opposed to the first set of fins.

In one aspect, the pin is insertable into the bore in the bracket until the driving head on the pin seats against the bracket.

In one aspect, the at least one finger of the bracket includes a pair of fingers, and each finger of the bracket is disposed within an opening in the bracket that extends through a sidewall of the bracket to the bore in the bracket.

In one aspect, each receptacle of the at least one receptacle includes an open-ended slot and a pair of flexible tabs extending into the slot.

In one aspect, the coupling head of the pin is a rounded head, and the at least one finger of the bracket engages an underside surface of the rounded head when the pin is in the first position.

In one aspect, the driving head has a noncircular shape for engagement with a driving tool to rotate the pin relative to the bracket.

In one aspect, the driving head includes an internal head having a hexalobular shape.

In one aspect, the driving head includes an external head having a hexagonal shape.

In one aspect, the elongated body of the pin includes an outwardly flared section that engages the bore in the bracket and thereby prevents the pin from tilting relative to a longitudinal axis of the bore when the pin is in the first position.

Another example of an assembly for securing at least one tube to a threaded stud also includes a pin and a bracket. The pin includes an elongated body, a driving head disposed at an end of the pin, and a ledge projecting radially outward from the elongated body, the pin having a bore for receiving the threaded stud. The bracket includes at least one finger and at least one receptacle for receiving and retaining the at least one tube. The pin is insertable into a bore in the bracket to a first position in which the at least one finger of the bracket engages the ledge on the pin and thereby inhibits withdrawal of the pin from the bore in the bracket. The driving head is spaced apart from the bracket when the pin is in the first position.

In one aspect, the driving head has a noncircular shape for engagement with a driving tool to rotate the pin relative to the bracket.

In one aspect, the pin is insertable into the bore in the bracket until the driving head on the pin seats against the bracket.

In one aspect, the at least one finger of the bracket includes a pair of fingers disposed on opposite sides of the bore in the bracket.

In one aspect, the pin includes one of a pair of fingers and two sets of fins disposed on opposite sides of the bore in the pin and configured to engage threads on the threaded stud when the bore in the bracket is placed over the threaded stud and the bracket is seated against an object to which the stud is mounted while the pin is in the first position.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a perspective view of an example of an assembly including a driving pin and a housing body according to the present disclosure, with the assembly shown in its as-formed condition;

FIG. 1B is a sectioned side view of the assembly of FIG. 1A in its as-formed condition;

FIG. 1C is a top view of the assembly of FIG. 1A in its as-formed condition;

FIG. 1D is a bottom view of the assembly of FIG. 1A in its as-formed condition;

FIG. 2A is a perspective view of the assembly of FIG. 1A in its shipping condition;

FIG. 2B is a sectioned side view of the assembly of FIG. 1A in its shipping condition;

FIG. 3A is a perspective view of the assembly of FIG. 1A in its temporary installed condition;

FIG. 3B is a sectioned side view of the assembly of FIG. 1A in its temporary installed condition;

FIG. 4A is a perspective view of the assembly of FIG. 1A in its fully installed condition;

FIG. 4B is a sectioned side view of the assembly of FIG. 1A in its fully installed condition;

FIG. 5A is a perspective view of another example of an assembly including a driving pin and a housing body according to the present disclosure, with the assembly shown in its as-formed condition; and

FIG. 5B is an enlarged perspective view of a portion of the assembly of FIG. 5A.

In the drawings, reference numbers may be reused to identify similar and/or identical elements.

### DETAILED DESCRIPTION

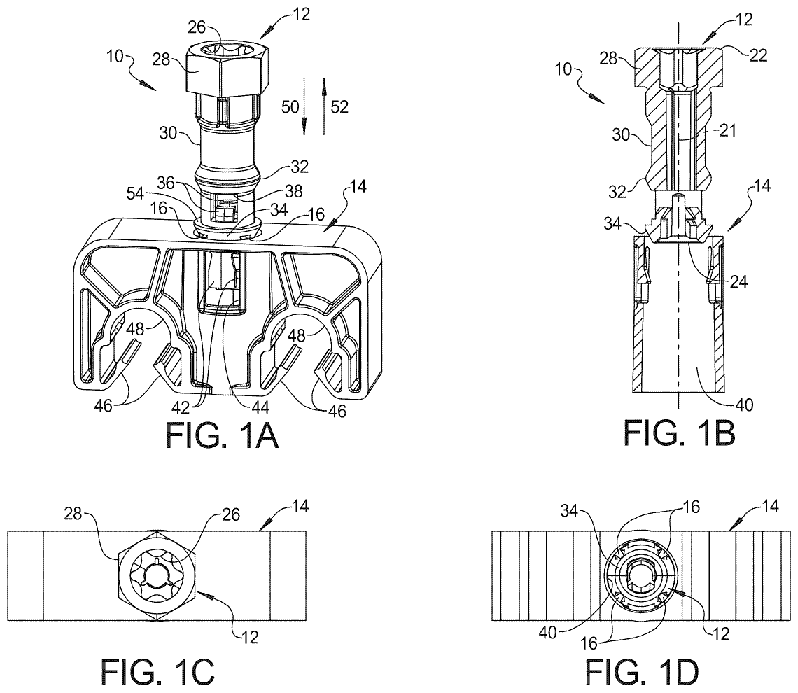

Referring to FIGS. 1 through 4, an assembly 10 includes a driving pin 12 and a bracket or housing body 14 that are connected to one another via frangible gates 16. The assembly 10 can be formed from plastic as a single piece using a single injection tool. The gates 16 allow plastic to flow from one part of a mold to another part of the mold. Each gate 16 may be a thin strip.

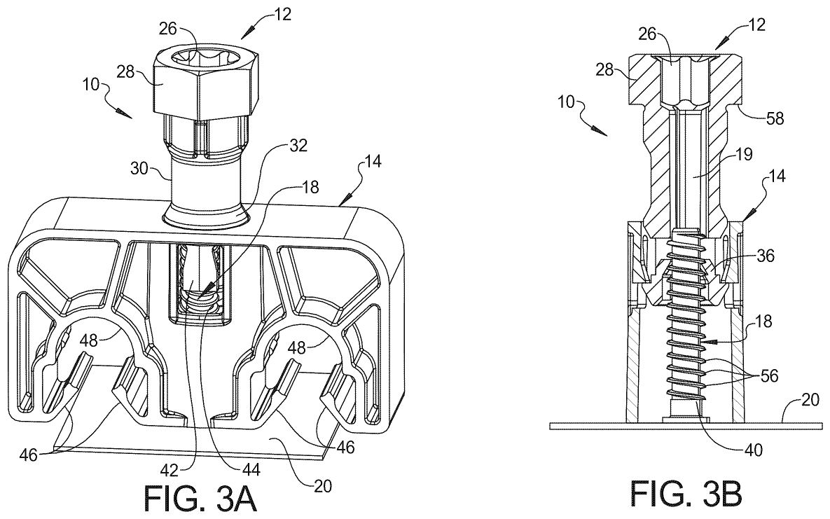

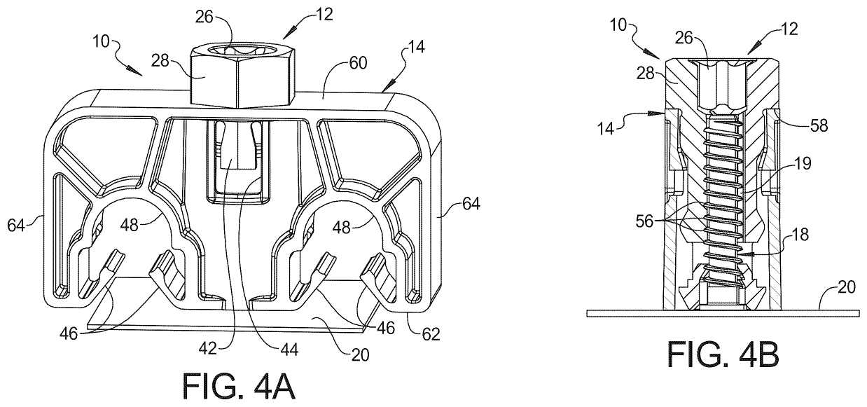

The assembly 10 is attachable to a threaded rod or weld stud 18 (FIGS. 3B and 4B). In the example shown, the stud 18 is mounted to a panel 20, such as a vehicle panel, and the body 14 is configured to secure tubes such as brake lines. However, the body 14 may be configured to secure other structures to the stud 18, and the stud 18 may be mounted to an object other than a panel. In one example, the stud 18 is a T5 stud having a length of 14.2 millimeters.

The pin 12 has an elongated (e.g., cylindrical) body with a bore 19 extending therethrough along a longitudinal axis 21 of the assembly 10 between a first end 22 and a second end 24. The pin 12 includes an internal head 26 and an external head 28 disposed at the first end 22 of the pin 12. A driving tool can be attached to the internal or external head 26 or 28 to (e.g., manually) rotate the pin 12 relative to the body 14.

In the example shown, the internal head 26 is hexalobular, and the external head 28 is hexagonal. However, the internal and external heads 26 and 28 may have other noncircular shapes. The pin 12 further includes a reduced diameter section 30, an outwardly flared section 32, a semi-spherical section or rounded head 34 disposed at the second end 24 of the pin 12, and a pair of fingers 36 disposed within an opening 38 extending through the pin 12 (e.g., in a direction perpendicular to the bore 19 in the pin 12). The internal and external heads 26 and 28 may be collectively or individually referred to as a driving head, and the rounded head 34 may be referred to as a coupling head. The fingers 36 extend into the bore 19 in the pin 12 at nonzero angle with respect to the longitudinal axis 21.

In the example shown, the body 14 is a general rectangular body with a cylindrical bore 40 extending therethrough along the longitudinal axis 21. However, the body 14 may have a shape other than rectangular. For example, the body 14 may be a cylindrical body. The gates 16 extend between the bore 40 of the body 14 and the rounded head 34 of the pin 12.

The body 14 includes a pair of fingers 42 disposed within an opening 44 extending through the body 14 (e.g., in a direction perpendicular to the bore 40), and a pair of tabs 46 disposed within each of a pair of open-ended slots 48 extending through the body 14. The fingers 42 are disposed on opposite sides of the bore 40 in the body 14. The slots 48 are configured to receive tubes such as brake lines. The tabs 46 are configured to flex outward as the tubes are inserted into the slots 48, and then return to their relaxed state (shown) to secure the tubes within the slots 48. Each slot 48 and corresponding pair of tabs 46 forms a receptable that is configured to receive and retain one of the tubes.

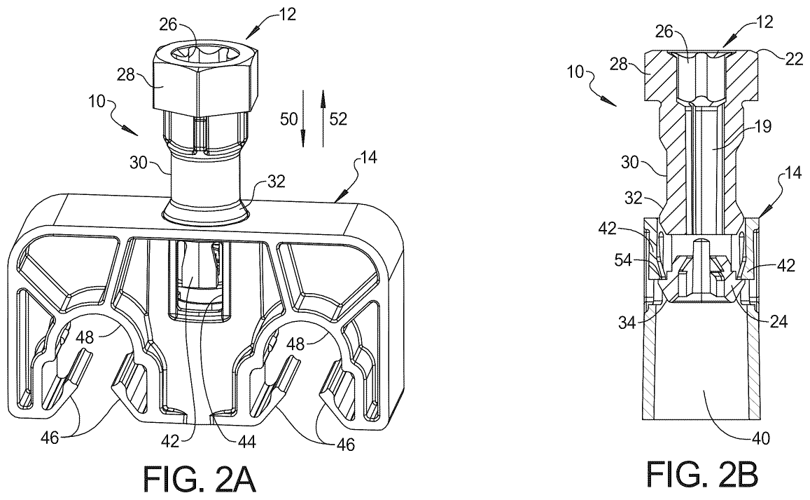

FIGS. 1A through 1D show the assembly 10 in its as-formed condition. After the assembly 10 is formed, an axial force is applied to the pin 12 (e.g., by the injection tool) in a first direction 50 along the longitudinal axis 21, which breaks the gates 16 and thereby separates the pin 12 from the body 14. The pin 12 is moved in the first direction 50 to insert the pin 12 into the bore 40 in the body 14 until the rounded head 34 of the pin 12 is past the fingers 42 of the body 14 as shown in FIGS. 2A and 2B.

The fingers 42 of the body 14 flex radially outward as the rounded head 34 is moved past the fingers 42, and then return to their relaxed state (shown) after the head 34 is past the fingers 42. Subsequently, if the pin 12 moves in a second direction 52 opposite of the first direction 50, the fingers 42 engage an underside or annular surface 54 of the rounded head 34 to prevent removal of the pin 12 from the bore 40 in the body 14. The assembly 10 may be shipped in its condition shown in FIGS. 2A and 2B. In this condition, the engagement between the flared section 32 of the pin 12 and the bore 40 in the body 14 prevents the pin 12 from tilting relative to the longitudinal axis 21. The annular surface 54 may be referred to as a ledge.

FIGS. 3A and 3B show the assembly 10 in a temporary installed condition. To transition from the shipping condition of FIGS. 2A and 2B to the temporary installed condition of FIGS. 3A and 3B, the assembly 10 is positioned so that the bore 19 in the pin 12 is aligned with the stud 18, and then the assembly 10 is moved toward the panel 20 to insert the stud 18 into the bore 19. When the stud 18 contacts the fingers 36 of the pin 12, the pin 12 may be rotated relative to the body 14 to move threads 56 on the stud 18 past the fingers 36 and insert the stud 18 further into the bore 19 in the pin 12 until it reaches the position shown in FIGS. 3A and 3B. Alternatively, instead of rotating the pin 12, the assembly 10 may simply be moved further toward the panel 20 to insert the stud 18 further into the bore 19 in the pin 12 and seat a bottom surface 62 of the body 14 against the panel 20 as shown in FIGS. 3A and 3B. The engagement between the fingers 36 and the stud 18 at least temporarily attaches the assembly 10 to the stud 18. Tubes may be inserted into the slots 48 in the body 14 before attaching the assembly 10 to the stud 18.

FIGS. 4A and 4B show the assembly 10 fully installed onto the stud 18. To transition from the temporary installed condition of FIGS. 3A and 3B to the fully installed condition of FIGS. 4A and 4B, the pin 12 is rotated relative to the body 14 to move the pin 12 further into the bore 40 in the body 14 and simultaneously thread the stud 18 into the bore 19 in the pin 12. As the pin 12 is rotated relative to the body 14, the threads 56 on the stud 18 create internal threads in the bore 19 in the pin 12. The pin 12 is tightened onto the stud 18 until an underside surface 58 of the external head 28 on the pin 12 engages a planar top surface 60 on the body 14. The reduced diameter section 30 of the pin 12 allows the fingers 42 of the body 14 to relax in this position, which improves the fatigue life of the fingers 42.

In the example shown, the slots 48 are oriented so that their open ends extend through the bottom surface 62 of the body 14. In other examples, the slots 48 may be oriented differently than shown. For example, the slots 48 may be oriented so that the open ends extend through the top surface 60 of the body 14 or through side surfaces 64 of the body 14. In addition, the slots 48 may be oriented different than one another.

There are three ways to verify installation of the assembly 10 onto the stud 18. First, a visual inspection may be performed to confirm that the external head 28 on the pin 12 is flush with f (or engages) the top surface 60 on the body 14 as shown in FIGS. 4A and 4B. Second, the torque applied to the internal or external head 26 or 28 can be measured to confirm that it falls within a predetermined range. Third, the amount that a driving tool linearly deflects as the driving tool tightens the pin 12 onto the stud 18 can be measured to confirm that it falls within a predetermined range.

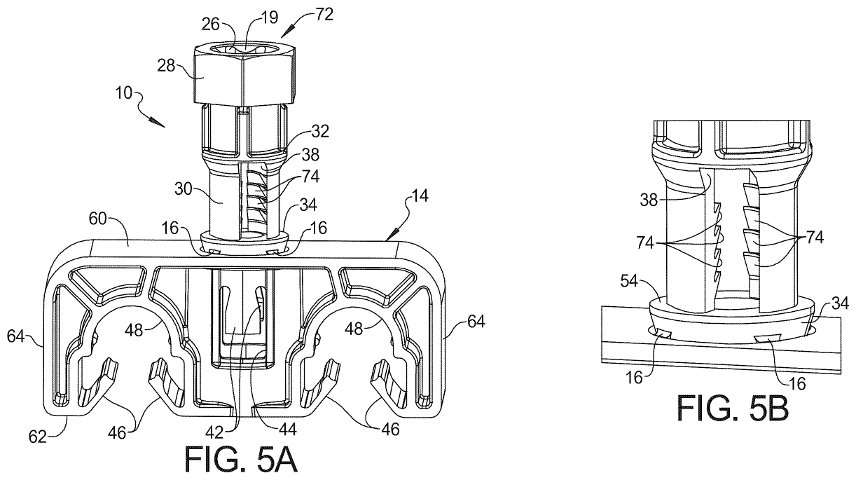

Referring now to FIGS. 5A and 5B, an assembly 70 is shown that is similar or identical to the assembly 10 except that the assembly 70 includes a pin 72 in place of the pin 12. The pin 72 is similar or identical to the pin 12 except that the pin 72 includes a plurality of retention fingers or fins 74 in place of the pair of fingers 36. A first set of the fins 74 is diametrically opposed to a second set of the fins 74 (e.g., the first and second sets of the fins 74 are disposed on opposite sides of the bore 19 in the pin 72).

The assembly 70 is adjusted from its as-formed condition to its shipping condition in the same way that assembly 10 is adjusted from its as-formed condition to its shipping condition. The assembly 70 is attached to the stud 18 in a similar or identical manner as the assembly 10. The assembly 70 is positioned so that the bore 19 in the pin 72 is aligned with the stud 18, and then the assembly 70 is moved toward the panel 20 to insert the stud 18 into the bore 19. When the stud 18 contacts the fins 74 of the pin 72, the pin 72 may be rotated relative to the body 14 to move the threads 56 on the stud 18 past the fins 74 and insert the stud 18 further into the bore 19 in the pin 72. Alternatively, instead of rotating the pin 72, the assembly 70 may simply be moved further toward the panel 20 to insert the stud 18 further into the bore 19 in the pin 72 and seat the bottom surface 62 of the body 14 against the panel 20.

The pin 72 is then rotated relative to the body 14 to move the pin 72 further into the bore 40 in the body 14 and simultaneously thread the stud 18 into the bore 19 in the pin 72. The pin 72 is tightened onto the stud 18 until the underside surface 58 of the external head 28 on the pin 72 engages the top surface 60 on the body 14. Installation of the assembly 70 onto the stud 18 may be verified in the same ways that installation of the assembly 10 onto the stud 18 may be verified.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.).

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “and/or” includes any and all combinations of one or more of the associated listed items. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. An assembly for securing at least one tube to a threaded stud, the assembly comprising:
a pin including an elongated body, a driving head disposed at a first end of the pin, and a coupling head disposed at a second end of the pin, the pin having a bore for receiving the threaded stud; and
a bracket including at least one finger and at least one receptacle for receiving and retaining the at least one tube, wherein the pin is insertable into a bore in the bracket to a first position in which the at least one finger of the bracket engages the coupling head and thereby inhibits withdrawal of the pin from the bore in the bracket, and the pin is rotatable relative to the bracket using the driving head to thread the pin onto the threaded stud and thereby insert the pin further into the bore in the bracket.

2. The assembly of claim 1 wherein the bore in the pin is unthreaded when the pin is formed, and rotating the pin relative to the bracket while the threaded stud is positioned in the bore of the pin creates internal threads in the bore of the pin.

3. The assembly of claim 1 wherein the pin and the bracket are formed as a single piece with a plurality of frangible gates connecting the pin to the bracket, and inserting the pin into the bore in the bracket to the first position breaks the gates.

4. The assembly of claim 3 wherein gates extend between the bore of the bracket and the coupling head of the pin.

5. The assembly of claim 1 wherein the pin includes a pair of fingers configured to engage threads on the threaded stud when the threaded stud is inserted into the bore in the pin, and each finger of the pin is disposed within an opening in the pin that extends through a sidewall of the pin to the bore in the pin.

6. The assembly of claim 5 wherein when the bore in the bracket is placed over the threaded stud and the bracket is seated against an object to which the threaded stud is mounted, the fingers of the pin engage the threads on the threaded stud and thereby retain the assembly on the threaded stud.

7. The assembly of claim 1 wherein the pin includes a plurality of fins configured to engage threads on the threaded stud when the threaded stud is inserted into the bore in the pin, the plurality of fins including a first set of fins and a second set of fins diametrically opposed to the first set of fins.

8. The assembly of claim 1 wherein the pin is insertable into the bore in the bracket until the driving head on the pin seats against the bracket.

9. The assembly of claim 1 wherein the at least one finger of the bracket includes a pair of fingers, and each finger of the bracket is disposed within an opening in the bracket that extends through a sidewall of the bracket to the bore in the bracket.

10. The assembly of claim 1 wherein each receptacle of the at least one receptacle includes an open-ended slot and a pair of flexible tabs extending into the slot.

11. The assembly of claim 1 wherein the coupling head of the pin is a rounded head, and the at least one finger of the bracket engages an underside surface of the rounded head when the pin is in the first position.

12. The assembly of claim 1 wherein the driving head has a noncircular shape for engagement with a driving tool to rotate the pin relative to the bracket.

13. The assembly of claim 1 wherein the driving head includes an internal head having a hexalobular shape.

14. The assembly of claim 1 wherein the driving head includes an external head having a hexagonal shape.

15. The assembly of claim 1 wherein the elongated body of the pin includes an outwardly flared section that engages the bore in the bracket and thereby prevents the pin from tilting relative to a longitudinal axis of the bore when the pin is in the first position.

16. An assembly for securing at least one tube to a threaded stud, the assembly comprising:
a pin including an elongated body, a driving head disposed at an end of the pin, and a ledge projecting radially outward from the elongated body, the pin having a bore for receiving the threaded stud; and
a bracket including at least one finger and at least one receptacle for receiving and retaining the at least one tube, wherein the pin is insertable into a bore in the bracket to a first position in which the at least one finger of the bracket engages the ledge on the pin and thereby inhibits withdrawal of the pin from the bore in the bracket, wherein the driving head is spaced apart from the bracket when the pin is in the first position.

17. The assembly of claim 16 wherein the driving head has a noncircular shape for engagement with a driving tool to rotate the pin relative to the bracket.

18. The assembly of claim 16 wherein the pin is insertable into the bore in the bracket until the driving head on the pin seats against the bracket.

19. The assembly of claim 16 wherein the at least one finger of the bracket includes a pair of fingers disposed on opposite sides of the bore in the bracket.

20. The assembly of claim 16 wherein the pin includes one of a pair of fingers and two sets of fins disposed on opposite sides of the bore in the pin and configured to engage threads on the threaded stud when the bore in the bracket is placed over the threaded stud and the bracket is seated against an object to which the stud is mounted while the pin is in the first position.
